(19) United States
(12) Patent Application Publication
(10) Pub. No.: US 2020/0300019 A1
(43) Pub. Date: Sep. 24, 2020

(54) WINDOW WIND-UP CONTROL

(71) Applicant: Pony.ai, Inc., Fremont, CA (US)

(72) Inventor: Robert Dingli, Cupertino, CA (US)

(21) Appl. No.: 16/358,059

(22) Filed: Mar. 19, 2019

(51) Int. Cl. E05F 15/43; E05F 15/695; E05F 15/71

(52) U.S. Cl. CPC E05F 15/431; E05F 15/695; E05Y 2900/55; E05F 2015/435; E05F 15/71

(57) ABSTRACT

Systems, methods, and non-transitory computer readable media may be configured to control wind up of windows. A window of a vehicle may be controlled to start a window closing motion. Interior activity information for the vehicle may be obtained. The interior activity information may characterize activity inside the vehicle. A window obstruction event for the window may be detected based on the interior activity information. The window obstruction event may include an object obstructing the window closing motion. Responsive to detection of the window obstruction event, the window closing motion may be stopped before the window touches the object.

### FIELD OF THE INVENTION

This disclosure relates to approaches for controlling wind-up of windows.

### BACKGROUND

A window of a vehicle may be being closed (being wound-up). Winding up of a window of a vehicle may be hazardous to a person if a part of the person's body is obstructing the window closing motion.

### SUMMARY

Various embodiments of the present disclosure may include systems, methods, and non-transitory computer readable media configured to control wind-up of windows. A window of a vehicle may be controlled to start a window closing motion. Interior activity information for the vehicle may be obtained. The interior activity information may characterize activity inside the vehicle. A window obstruction event for the window may be detected based on the interior activity information. The window obstruction event may include an object obstructing the window closing motion. Responsive to detection of the window obstruction event, the window closing motion may be stopped before the window touches the object.

In some embodiments, the object may include a body part of a person.

In some embodiments, the object obstructing the window closing motion may include the object being in a path of the window closing motion or the object approaching the path of the window closing motion.

In some embodiments, a warning that the window is about to close may be provided before or with the start of the window closing motion. The warning may include an instruction to keep clear of an opening of the window.

In some embodiments, the window of the vehicle may be controlled to start the window closing motion responsive to an environmental condition of the vehicle. The environmental condition of the vehicle may include a weather condition of the vehicle or a speed condition of the vehicle.

In some embodiments, the interior activity information may be generated based on operation of one or more image sensors.

In some embodiments, the interior activity information may be generated based on operation of one or more proximity sensors.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example environment for controlling wind-up of windows, in accordance with various embodiments.

FIG. 2 illustrates an example environment for controlling wind-up of windows, in accordance with various embodiments.

FIG. 3 illustrates an example environment for controlling wind-up of windows, in accordance with various embodiments.

FIG. 4 illustrates a flowchart of an example method, in accordance with various embodiments.

FIG. 5 illustrates a block diagram of an example computer system in which any of the embodiments described herein may be implemented.

### DETAILED DESCRIPTION

In various implementations, wind-up of windows may be controlled based on detection of a window obstruction event. A window of a vehicle may be controlled to start a window closing motion. Interior activity information for the vehicle may be obtained. The interior activity information may characterize activity inside the vehicle, such as activity of a driver or activity of one or more passengers. A window obstruction event for the window may be detected based on the interior activity information. A window obstruction event may refer to an event in which an object may be, will be, or will likely be in the path of the closing window. The window obstruction event may include an object (e.g., a body part of a person, a thing) obstructing the window closing motion. For example, the object obstructing the window closing motion may include the object being in a path of the window closing motion or the object approaching the path of the window closing motion. Responsive to detection of the window obstruction event, the window closing motion may be stopped before the window touches the object.

Before or with the start of the window closing motion, one or more warnings that the window is about to close may be provided. The warning may include one or more instructions to keep clear of an opening of the window.

The window of the vehicle may be controlled to start the window closing motion responsive to one or more environmental conditions of the vehicle. An environmental condition of the vehicle may include a weather condition of the vehicle (e.g., rain, snow, high wind) or a speed condition of the vehicle (e.g., driving speed of the vehicle, relative driving speed of the vehicle with respect to other vehicles or objects).

The interior activity information may be generated based on operation of one or more sensors, such as image sensors and/or proximity sensors.

The approaches disclosed herein provides for automatic control of window motion. Window closing motion of a window may be stopped if an objected is detected to be obstructing the window closing motion. The window closing motion may be stopped before the window touches the object. Such automatic control of window motion may provide for safe closing of windows.

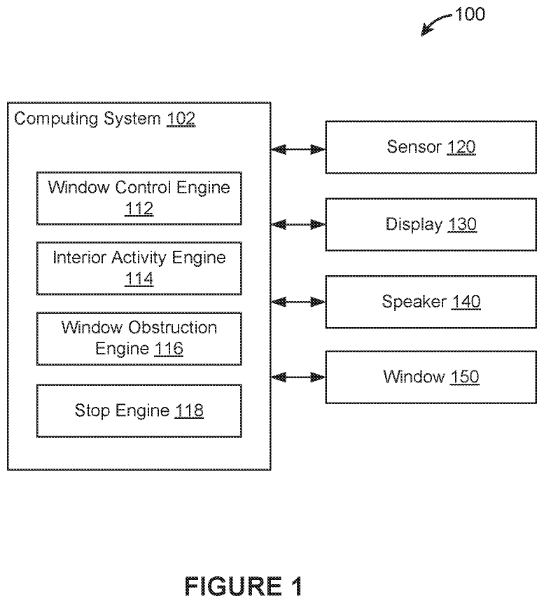

FIG. 1 illustrates an example environment 100 for controlling wind-up of windows, in accordance with various embodiments. The example environment 100 may include a computing system 102, a sensor 120, a display 130, a speaker 140, and a window 150. The computing system 102 may be communicatively, electrically, and/or mechanically coupled to one or more other components of the environment 100. For example, the computing system 102 may be coupled to the sensor 120, the display 130, the speaker 140, and/or the window 150 to control wind-up of the window 150. The coupling between the different components within the environment 100 may include direct coupling and/or indirect coupling. For example, coupling between the computing system 102 and the window 150 may include coupling between one or more components of the computing system 102 and one or more components of a vehicle that controls the wind-up of the window 150.

While components 102, 120, 130, 140, 150 of the environment 100 are shown in FIG. 1 as single entities, this is merely for ease of reference and is not meant to be limiting. For example, one or more components/functionalities of the computing system 102 described herein may be implemented, in whole or in part, within a single computing device or within multiple computing devices. The sensor 120, the display 130, the speaker 140, and/or the window 150 may include a single tool/component or multiple tools/components that provide functionalities described herein. For example, the sensor 120 may include a single sensor, multiple sensors of the same type, or different types of sensors. As another example, the window 150 may include a single window of a vehicle or multiple windows of the vehicle.

The sensor 120 may refer to a tool or a device that monitors (e.g., measure, ascertain, detect, estimate) one or more physical properties. A sensor may record, indicate, and/or otherwise respond to the measured physical propert(ies). For example, the sensor 120 may include one or more image sensor, one or more proximity sensors, and/or other sensors. An image sensor may include a sensor (e.g., camera, sensor within a camera) that detects and/or conveys information that constitutes an image or a video. The image sensor may be configured to capture image(s) and/or video(s) of one or more objects (e.g., person, body part of a person, a thing, a thing used by a person) inside the vehicle. The image(s) and/or video(s) may depict the location and/or the movement of the object inside the vehicle. The image(s) and/or video(s) may depict relative position of the object with respect to one or more windows of the vehicle. A proximity sensor may refer to a sensor that is able to detect presence of nearby objects without any physical contact. A proximity sensor may emit electromagnetic field and/or a beam of electromagnetic radiation (e.g., infrared) and look for changes in the field or return signal to sense whether an object is nearby (e.g., in the path of the beam emitted by the proximity sensor). Probity sensor measurements may include measurements of the field or return signal, and/or other information determined based on such information. The image(s), video(s), proximity sensor measurement(s), and/or other measurements of physical propert(ies) by the sensor 120 may be used to determine whether one or more objects are in the path of a window closing motion of a window and/or are approaching the path of the window closing motion of a window. Information measured, determined, recorded, and/or otherwise generated by the sensor 120 may be included within and/or be used to determine/generate interior activity information for a vehicle.

The display 130 may refer to a tool or a device that visually presents information (e.g., displaying one or more images, one or more videos, one or more text, one or more graphics, and/or other visual information). The display 130 may be positioned within, positioned outside, carried by, and/or affixed to a vehicle. The display 130 may present visual information itself (e.g., the display 130 includes a monitor) and/or may present visual information using a projecting surface (e.g., the display 130 includes a projector). The display 130 may refer to a single device (e.g., single monitor) or multiple devices (e.g., multiple monitors) working in coordination to display visual information.

The speaker 140 may refer to a tool or a device that audibly presents information (e.g., playing recorded and/or simulated audio/sound). The speaker 140 may be positioned within, positioned outside, carried by, and/or affixed to a vehicle. The speaker 140 may refer to a single device (e.g., single speaker) or multiple devices (e.g., multiple speakers) working in coordination to present audible information. The speaker 140 may include one or more transducers that convert electrical signals into sound waves.

The window 150 may refer to a window of a vehicle. A vehicle may refer to a thing used to transport one or more persons and/or one or more things. Examples of vehicle may include an autonomous vehicle, a non-autonomous vehicle, a taxi, a ride-share vehicle, a vehicle owned by an organization, a personally owned vehicle, and/or other vehicles. The window 150 may include an opening of a vehicle. The window 150 may include glass and/or other transparent/semi-transparent material positioned to be fitted in a frame (e.g., window frame of a vehicle door, window frame of a vehicle body). The window 150 may include and/or be coupled with one or more components of the vehicle that controls movement (e.g., wind-up, wind-down) of the window 150, such as a motor, a window guide, a control switch, and/or other mechanical/electronical components. The winding up of the window 150 may include upward motion of the window 150 to close the window 150. The winding down of the window 150 may include downward motion of the window to open the window 150.

The computing system 102 may include one or more processors and memory. The processor(s) may be configured to perform various operations by interpreting machine-readable instructions stored in the memory. The environment 100 may also include one or more datastores that are accessible to the computing system 102 (e.g., stored in the memory of the computing system 102, coupled to the computing system, accessible via one or more network(s)). In some embodiments, the datastore(s) may include various databases, application functionalities, application/data packages, and/or other data that are available for download, installation, and/or execution. The computing system 102 may include a window control engine 112, an interior activity engine 114, a window obstruction engine 116, a stop engine 118, and/or other engines.

In various embodiments, the window control engine 112 may be configured to control one or more windows of a vehicle. For example, the window control engine 112 may be configured to control the window 150. Controlling the window 150 may include controlling whether and/or how the window 150 moves. The window control engine 112 may control the window 150 to wind the window 150 up or down. Motion of the window 150 to close (wind up) may be referred to as a window closing motion. The window control engine 112 may control the window 150 to start the window closing motion, set and/or adjust one or more parameters (e.g., direction, speed, and/or acceleration) of the window closing motion.

In some embodiments, the window 150 may be controlled to start the window closing motion after confirming that no object(s) are in the path of the window closing motion and/or that no object(s) are approaching the path of the window closing motion. For example, one or more image sensors and/or one or more proximity sensors may be used to determine whether one or more objects (e.g., passenger(s), thing(s)) are close to the window 150, are positioned in the opening of the window 150, and/or approaching the window 150/opening of the window 150. If an object is detected to be close the window 150, positioned in the opening of the window 150, and/or approaching the window 150/opening of the window 150, the window closing motion may not be started. Additionally and/or in alternative, one or more instructions may be provided visually via the display 130 and/or audibly via the speaker 140 to move away from the window 150/opening of the window 150.

In some embodiments, one or more warnings that the window 150 is about to close may be provided before or with the start of the window closing motion. The warning may include provision of information that the window 150 is closing or is about to be closed. The warning may include one or more instructions to keep clear of an opening of the window 150. For example, before or with the start of the window closing motion, the warning the window 150 is about to close and/or to keep clear of the opening of the window 150 may be provided visually via the display 130 and/or audibly via the speaker 140. Other provisions of warning are contemplated.

The window control engine 112 may control the window 150 to start the window closing motion based on user input. For example, the window control engine 112 may start the window closing motion of the window 150 based on reception of a user input (e.g., signal generated from a user using vehicle control to close the window 150) indicating that the window 150 should be closed. As another example, the window control engine 112 may start the window closing motion of the window 150 responsive to one or more environment conditions of the vehicle.

An environment condition of a vehicle may refer to condition of the surrounding and/or interior of the vehicle. An environment condition of the vehicle may be dependent or independent of the vehicle operation. For example, the environmental condition of a vehicle may include a weather condition of the vehicle or a speed condition of the vehicle. A weather condition of the vehicle may include weather condition of the vehicle location. A speed condition of the vehicle may include a speed with which the vehicle is traveling. For example, the weather condition of the vehicle (e.g., detected based on environmental sensor, detected based on communication with a weather reporting service) may indicate that the vehicle is located and/or traveling in an area with rain, snow, high wind, and/or other environmental conditions that make driving with the window 150 open unadvisable and/or unpleasant. As another example, the speed condition of the vehicle (e.g., detected based on a vehicle sensor) may indicate that the vehicle is traveling at a speed/acceleration (e.g., driving speed of the vehicle, relative driving speed of the vehicle with respect to other vehicles or objects) that makes driving with the window 150 open unadvisable and/or unpleasant. As another example, a condition of an interior of the vehicle may include activity taking place inside the vehicle and/or presence of objects inside the vehicle. Certain amount of motion, motion by certain objects, and/or presence of certain objects may make driving with the window 150 open unadvisable. For instance, presence of children of certain age and/or certain types of activity taking place in the vehicle may make driving with the window 150 unsafe. Responsive to such environmental conditions of the vehicle (e.g., based on detection of such environment conditions of the vehicle), window control engine 112 may control the window 150 to automatically start the window closing motion.

In various embodiments, the interior activity engine 114 may be configured to obtain interior activity information for the vehicle. Obtaining interior activity information may include accessing, acquiring, analyzing, determining, examining, generating, identifying, loading, locating, opening, receiving, retrieving, reviewing, storing, and/or otherwise obtaining the interior activity information. Interior activity information may be obtained from one or more storage locations. A storage location may refer to electronic storage located within the computing system 102 (e.g., integral and/or removable memory of the computing system 102), electronic storage coupled to the computing system 102, and/or electronic storage located remotely from the computing system 102 (e.g., electronic storage accessible to the computing system 102 through a network). Interior activity information may be stored within a single file or across multiple files.

Interior activity information may characterize activity inside the vehicle. For example, the interior activity information may characterize activity of a driver or activity of one or more passengers of the vehicle. Interior activity information characterizing activity inside the vehicle may include the interior activity information characterizing position and/or motion of one or more objects (e.g., persons, parts of persons, things, parts of things) within the vehicle. Interior activity information characterizing activity inside the vehicle may include the interior activity information characterizing location and/or movement of objects inside the vehicle. For example, interior activity information for a vehicle may characterize relative position of an object and/or relative movement of an object with respect to one or more windows of the vehicle. Interior activity information may be used to determine whether one or more objects are in the path of a window closing motion of a window and/or are approaching the path of the window closing motion of a window. Interior activity information for a vehicle may be generated based on operation of one or more sensors (e.g., the sensor 120), such as image sensor(s), proximity sensor(s), and/or other sensors.

In various embodiments, the window obstruction engine 116 may be configured to detect one or more window obstruction events for one or more windows of a vehicle based on the interior activity information and/or other information. For example, the window obstruction engine 116 may detect one or more window obstruction events for the window 150 based on the interior activity information for a vehicle. For instance, based on the interior activity information for a vehicle characterizing an object being in the opening of the window 150, and/or an object being relatively positioned and relative moving towards the opening of the window 150 such that the object is likely to be in the opening of the window 150 during the window closing motion, the window obstruction engine 116 may detect one or more window obstruction events.

A window obstruction event may refer to an event that indicates that the window closing motion of a window may be blocked, made difficult, hindered, and/or otherwise obstructed. A window obstruction event may refer to an event in which one or more objects may be, will be, or will likely be in the path of the closing window. A window obstruction event may include one or more objects (e.g., a person, a body part of a person, a thing, a part of a thing) obstructing the window closing motion. For example, a window obstruction event may include one or more of the following events: an object being in a path of the window closing motion, an object approaching the path of the window closing motion. For instance, a window obstruction event may include a person's body part or a thing being in the opening of the window 150, or the person's body part or the thing moving towards the opening of the window. Other window obstruction events are contemplated.

In various embodiments, the stop engine 118 may be configured to stop one or more window closing motion of one or more windows. For example, the stop engine 118 may be configured to stop a window closing motion of the window 150. Stopping the window closing motion of the window 150 may include slowing the window closing motion until the window 150 stops moving (up or down) and/or opposing the window closing motion such that the window closing motion is reversed (stop the window closing motion and start the window opening motion). The stop engine 118 may, responsive to detection of a window obstruction event for the window 150, stop the window closing motion of the window 150. The window closing motion of the window 150 may be stopped before the window 150 touches the object. For example, one way of stopping a window closing motion may include detecting resistance to the window closing motion. Increase in resistance to the window closing motion may indicate that an object is in the path of the window closing motion and that the window has touched the object. However, closing the window based on such detection of objects obstructing the window closing motion requires the window to touch, contact, or hit the object, which may harm the object (e.g., a window closing motion hurting a passenger by hitting a body part of the passenger). Rather, by using the interior activity information to detect a window obstruction event and stopping the window closing event responsive to detection of the window obstruction event, the window 150 may be stopped before the window 150 touches, contacts, or hits the object.

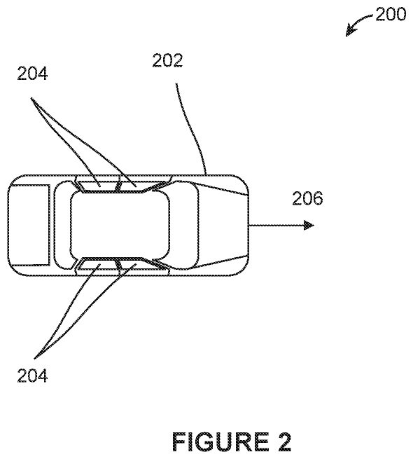

FIG. 2 illustrates an example environment 200 for controlling wind-up of windows, in accordance with various embodiments. The environment 200 may include a vehicle 202. The vehicle 202 may include windows 204. The vehicle 202 may be moving in a direction 206. One or more of the windows 204 may be automatically controlled (e.g., automatically wound-up, automatically wound-down, automatically moved, automatically stopped). For example, the windows 204 may be open while the vehicle 202 is moving through a weather event, such as rain, snow, hail, and/or high-speed window. Based on the detection of the weather event, the window closing motion for the windows 204 may be started. During the window closing motion, one or more window obstruction events may be detected for one or more of the windows 204. For example, an object may be in the path of a window closing motion or approaching the path of the window closing motion. Responsive to detection of a window obstruction event, the window closing motion for the corresponding window may be stopped. The window closing motion may be stopped before the corresponding window touches the object (e.g., hits the object with the top edge of the window).

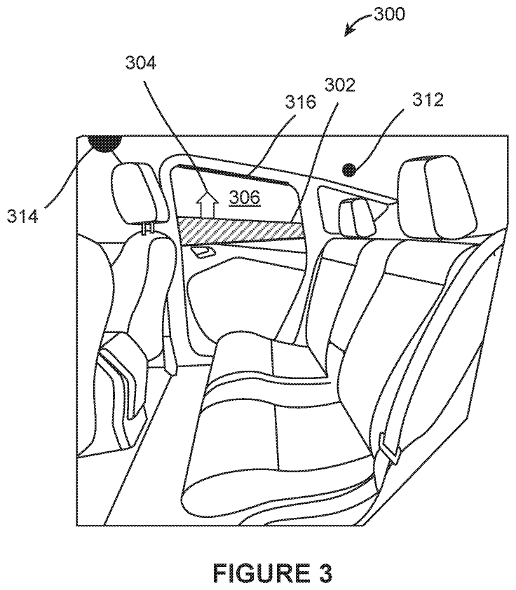

FIG. 3 illustrates an example environment 300 for controlling wind-up of windows, in accordance with various embodiments. The environment 300 may include a cabin of a vehicle with a window 302 undergoing a window closing motion 304. The window closing motion 304 may include the window 302 moving upward to fill up the open space 306 above the window 302. The vehicle may include multiple sensors 312, 314, 316. The sensors 312, 314, 216 may be positioned to measure activity inside the vehicle. For example, the sensor 312 may include an image sensor positioned to the rear of the window 302 and directed to capture images and/or videos of objects approaching the window 302 and/or objects within the open space 306. As another example, the sensor 314 may include an image sensor positioned on the ceiling of the vehicle and having a wide-field of view (e.g., hemispherical field of view) to capture images and/or videos of objects approaching the window 302 and/or objects within the open space 306. As yet another example, the sensor 316 may include a proximity sensor positioned above the window 302 to detect objects near and/or within the open space 306.

Based on the information generated by one or more of the sensors 312, 314, 316, the activity inside the vehicle may be determined. Based on the activity inside the vehicle, one or more window obstruction event for the window 302 may be determined. A window obstruction event for the window 302 may include an object (e.g., a person, a part of a person, a thing, a part of a thing) obstructing the window closing motion 304. For example, an object may be in the path of the window closing motion 304 (e.g., in the open space 306) or approaching the path of the window closing motion 304 (e.g., approaching the open space 306). Responsive to detection of the window obstruction event, the window closing motion 304 of the window 302 may be stopped before the window 302 touches the object.

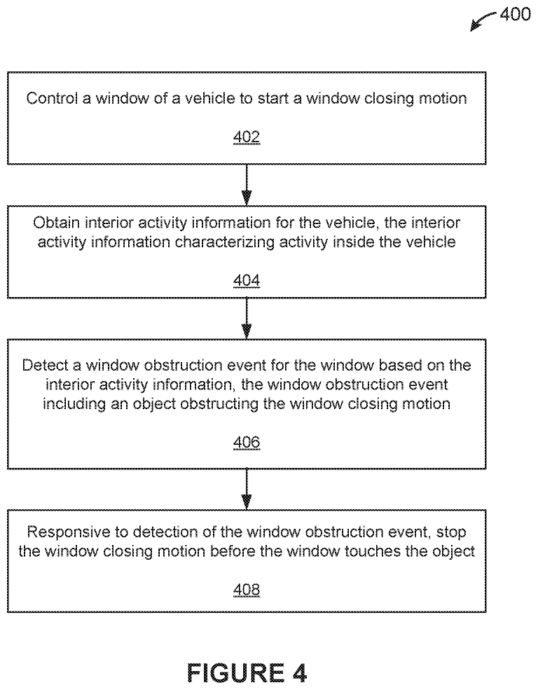

FIG. 4 illustrates a flowchart of an example method 400, according to various embodiments of the present disclosure. The method 400 may be implemented in various environments including, for example, the environment 100 of FIG. 1. The operations of method 400 presented below are intended to be illustrative. Depending on the implementation, the example method 400 may include additional, fewer, or alternative steps performed in various orders or in parallel. The example method 400 may be implemented in various computing systems or devices including one or more processors.

At block 402, a window of a vehicle may be controlled to start a window closing motion. At block 404, interior activity information for the vehicle may be obtained. The interior activity information may characterize activity inside the vehicle. At block 406, a window obstruction event for the window may be detected based on the interior activity information. The window obstruction event may include an object obstructing the window closing motion. At block 408, responsive to detection of the window obstruction event, the window closing motion may be stopped before the window touches the object.

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

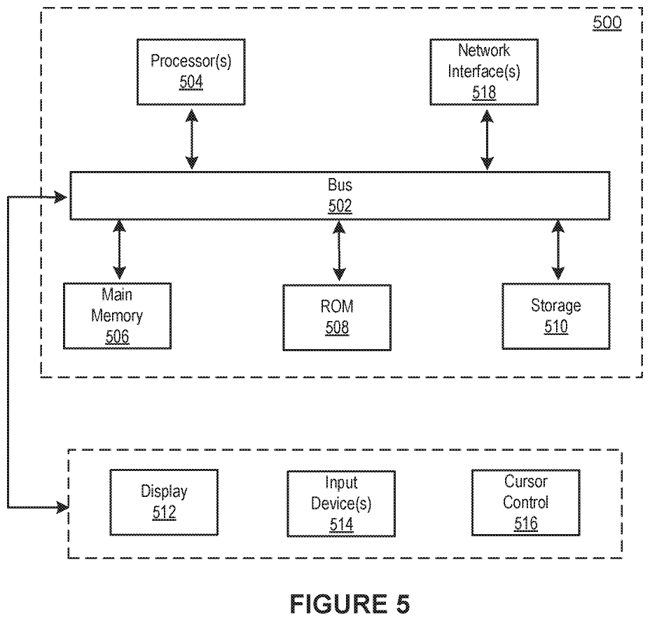

FIG. 5 is a block diagram that illustrates a computer system 500 upon which any of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to a display 512, such as a cathode ray tube (CRT) or LCD display (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may retrieves and executes the instructions. The instructions received by main memory 506 may optionally be stored on storage device 510 either before or after execution by processor 504.

The computer system 500 also includes a communication interface 518 coupled to bus 502. Communication interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN (or WAN component to communicated with a WAN). Wireless links may also be implemented. In any such implementation, communication interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### Engines, Components, and Logic

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A system comprising:
one or more processors; and
a memory storing instructions that, when executed by the one or more processors, cause the system to perform operations comprising:
controlling a window of a vehicle to start a window closing motion;
obtaining interior activity information for the vehicle, the interior activity information characterizing activity inside the vehicle;
detecting a window obstruction event for the window based on the interior activity information, the window obstruction event including an object obstructing the window closing motion; and
responsive to detection of the window obstruction event, stopping the window closing motion before the window touches the object.

2. The system of claim 1, wherein the object includes a body part of a person.

3. The system of claim 1, wherein the object obstructing the window closing motion includes the object being in a path of the window closing motion or the object approaching the path of the window closing motion.

4. The system of claim 1, wherein the operations further comprise:
providing a warning that the window is about to close before or with the start of the window closing motion.

5. The system of claim 4, wherein the warning includes an instruction to keep clear of an opening of the window.

6. The system of claim 1, wherein the window of the vehicle is controlled to start the window closing motion responsive to an environmental condition of the vehicle.

7. The system of claim 6, wherein the environmental condition of the vehicle includes a weather condition of the vehicle or a speed condition of the vehicle.

8. The system of claim 1, wherein the interior activity information is generated based on operation of one or more image sensors.

9. The system of claim 1, wherein the interior activity information is generated based on operation of one or more proximity sensors.

10. A method implemented by a computing system including one or more processors and storage media storing machine-readable instructions, wherein the method is performed using the one or more processors, the method comprising:
controlling a window of a vehicle to start a window closing motion;
obtaining interior activity information for the vehicle, the interior activity information characterizing activity inside the vehicle;
detecting a window obstruction event for the window based on the interior activity information, the window obstruction event including an object obstructing the window closing motion; and
responsive to detection of the window obstruction event, stopping the window closing motion before the window touches the object.

11. The method of claim 10, wherein the object includes a body part of a person.

12. The method of claim 10, wherein the object obstructing the window closing motion includes the object being in a path of the window closing motion or the object approaching the path of the window closing motion.

13. The method of claim 10, further comprising:
providing a warning that the window is about to close before or with the start of the window closing motion.

14. The method of claim 13, wherein the warning includes an instruction to keep clear of an opening of the window.

15. The method of claim 10, wherein the window of the vehicle is controlled to start the window closing motion responsive to an environmental condition of the vehicle.

16. The method of claim 15, wherein the environmental condition of the vehicle includes a weather condition of the vehicle or a speed condition of the vehicle.

17. The method of claim 10, wherein the interior activity information is generated based on operation of one or more image sensors.

18. The method of claim 10, wherein the interior activity information is generated based on operation of one or more proximity sensors.

19. A non-transitory computer readable medium comprising instructions that, when executed, cause one or more processors to perform:
controlling a window of a vehicle to start a window closing motion;
obtaining interior activity information for the vehicle, the interior activity information characterizing activity inside the vehicle;
detecting a window obstruction event for the window based on the interior activity information, the window obstruction event including an object obstructing the window closing motion; and
responsive to detection of the window obstruction event, stopping the window closing motion before the window touches the object.

20. The non-transitory computer readable medium of claim 19, wherein the window of the vehicle is controlled to start the window closing motion responsive to an environmental condition of the vehicle.
